(19) United States
(12) Patent Application Publication
(10) Pub. No.: US 2010/0250443 A1
(43) Pub. Date: Sep. 30, 2010

(54) METHOD AND APPARATUS FOR PROVIDING ONLINE PAYMENTS

(75) Inventors: Matti Karlsson, Viiala (FI); Jyri Vuorinen, Tampere (FI)

Correspondence Address: DITTHAVONG MORI & STEINER, P.C., 918 Prince Street, Alexandria, VA, 22314, US

(73) Assignee: Nokia Corporation, Helsinki (FI)

(21) Appl. No.: 12/412,696

(22) Filed: Mar. 27, 2009

(51) Int. Cl. G06Q 30/00; H04L 9/32

(52) U.S. Cl. 705/76; 705/34; 705/26

(57) ABSTRACT

An approach is provided for making and handling online payments. An indication that information identifying a bill is available is received. A user credential associated with the bill is retrieved. A request for the bill is generated, wherein the bill includes the user credential and the information. A bill authorization message is then generated.

### BACKGROUND

Users of mobile devices such as, for example, cellular telephones are no longer limited to just voice communications or simple text messaging. Instead these mobile devices can now access many networked resources and services that previously have been viable only for more traditional computing platforms. As more and more services become available for mobile devices to access, there will be a number of these services which will require some type of payment to access the service. Current approaches for making online payments for accessing services by mobile devices, especially pay-as-you-go services, lack both the usability and security to allow the seamless transactions mobile users will expect as more and more pay services become available.

### SOME EXEMPLARY EMBODIMENTS

Therefore, there is a need for an approach for making and handling online payments of mobile users that stores some secure payment-related information within a mobile device and which integrates the payment function seamlessly with underlying applications.

According to one embodiment, a method includes receiving an indication that information identifying a bill is available; and retrieving a user credential associated with the bill. The method also includes generating a request for the bill, including the user credential and the information; and generating a bill authorization message.

According to another embodiment, a computer-readable storage medium carrying one or more sequences of one or more instructions which, when executed by one or more processors, cause the one or more processors to at least perform the following steps: receiving an indication that information identifying a bill is available; retrieving a user credential associated with the bill; generating a request for the bill, including the user credential and the information; and generating a bill authorization message.

According to another embodiment, an apparatus includes a processor and a memory storing executable instructions. Furthermore, if the instructions are executed the apparatus performs at least the following: receiving an indication that information identifying a bill is available; retrieving a user credential associated with the bill; generating a request for the bill, including the user credential and the information; and generating a bill authorization message.

According to yet another embodiment, an apparatus comprises means for receiving an indication that information identifying a bill is available; means for retrieving a user credential associated with the bill; means for generating a request for the bill, including the user credential and the information; and means for generating a bill authorization message.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communications system capable of providing online payment, according to an exemplary embodiment;

FIG. 2A is a flowchart of a process for making an online payment, in accordance with one embodiment;

FIG. 2B is a flowchart of a process for utilizing context information when making an online payment, in accordance with one embodiment;

FIG. 3 is a flowchart of a process for handling an online payment, in accordance with one embodiment;

FIG. 4 is a diagram of a protocol for making online payments, in accordance with one embodiment;

FIG. 5 is a diagram of another protocol for making online payments, in accordance with one embodiment;

FIG. 6A is a diagram of a communications system, in accordance with one embodiment;

FIG. 6B is a diagram of a protocol for making online payments, in accordance with one embodiment;

FIG. 7A is a system diagram of functional components of a mobile user device, in accordance with one embodiment;

FIG. 7B is a system diagram of functional components that are a portion of a mobile user device, in accordance with one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile station (e.g., handset) that can be used to implement an embodiment of the invention.

### DESCRIPTION OF PREFERRED EMBODIMENT

A method and apparatus for making and handling online transactions and payments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

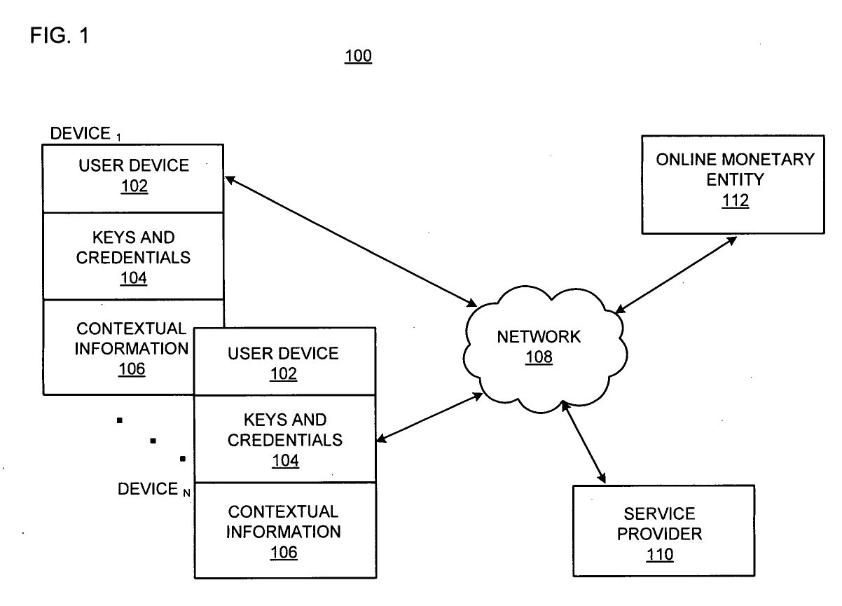

FIG. 1 is a diagram of a communications system capable of providing online payment, according to an exemplary embodiment, in accordance with one embodiment. System 100 provides an approach for handling online payments that is convenient and secure. By contrast, some traditional techniques for providing payment options to mobile users accessing pay services include making payments through the mobile operator (post paid or prepaid), using credit cards, and using payment services such as, for example, PayPal™. These approaches to providing mobile payment services, however, have a number of drawbacks that make the user experience cumbersome and insecure. In particular, these approaches are not integrated into the services themselves which diminishes their ease of use. Also, little or no customization is available that could simplify a user's experience and make handling transactions quicker. As for security, many of the payment approaches mentioned above require a user to enter credentials such as a user name, a password, a personal identification number (PIN), or some other information for each transaction. Not only does entering this information slow the transaction process but it also increases the insecurity of the transaction. To increase security, some payment techniques introduce one-time passwords but this increased security complicates both the payment transaction process and the information needed by a user to complete the transaction.

In the system 100, there are a number of user devices 102 that correspond to different mobile users. In particular each of the user devices 102 have respective information stored within. For example, among other data, the user device 102 can store user credentials and cryptographic keys 104. The user device 102 may also store contextual information 106 about the user device 102, its current environment, and past usage of the device. The user device 102 can any type of mobile terminal, fixed terminal, or portable terminal including mobile handsets, stations, units, devices, multimedia tablets, Internet nodes, communicators, desktop computers, laptop computers, Personal Digital Assistants (PDAs), or any combination thereof. It is also contemplated that the user device 102 can support any type of interface to the user (such as “wearable” circuitry, etc.).

The keys and credentials 104 may, for example, be user names for different accounts along with corresponding passwords. The credentials may also include information used to access a network service operator providing the user device 102 with access to the network 108. Cryptographic keys such as ones used in systems relying on RSA cryptography may be stored as well. In such a system both private and public keys are utilized and both can be stored on the user device 102. One of ordinary skill will recognize that there are other cryptographic techniques and authentication techniques that may be used and the appropriate information for these other approaches may also be stored on the user device 102.

By way of example, the communication network 108 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

One purpose for which a user device 102 may be utilizing the network 108 is to access a service provider 110. In particular, the service provider 110 may be providing a service for which the user device must pay. For example, the service provider 110 may allow the user to download information for which there is a cost. Thus, the user of the user device 102 must somehow initiate payment of funds to the service provider 110 in order to receive the desired services. The online monetary entity 112 plays a role in paying of funds to the service provider 110.

In at least one embodiment, the online monetary entity 112 is structured similar to a bank in that a user has an account that has available funds and upon order of the user, the funds are transferred to another party. Therefore, in the system 100 of FIG. 1, a user of user device 102 has previously created an account with the online monetary entity 112 and this account has funds as well. The funding of the account can be accomplished by wire transfer, credit card, a physical check, cash, or any of a variety of similar methods. In creating the account, the user and the online monetary entity 112 also exchange credential information so that the online monetary entity 112 can authenticate later communications purportedly received from the user. As mentioned above, this credential information could include RSA keys such that a message encrypted, or signed, using the user's private key may be authenticated using the corresponding public key. By storing these credentials and keys 104 on the user device 102, secure communication between the user device 102 and the online monetary entity may be streamlined without requiring a user to enter credential information in the course of a transaction.

In operation, a user of the user device 102 accesses a pay service offered by the service provider 110. In the course of that access, the service provider 110 indicates that a service or content requested by the user requires a payment. In response, the user instructs the online monetary entity 112 to pay the fees for the requested content or service. The online monetary entity 112 communicates to the service provider 110 that the fees have been paid and then the service provider 110 provides the requested service or content. In paying the fees, the online monetary entity 112 will likely initiate a transaction that debits the user's account for a certain amount of money and also credits an account designated by the service provider 110. The account of the service provider 110 may be an account with the online monetary entity 112 or with some other banking-type entity.

Alternatively, the service provider 110 can be an individual user, whereby the user with a user device can receive a person-to-person remittance. By way of example, one of user devices 102 can assume the role of the service provider 110 for conducting person-to-person transactions and payment with another one of the user devices 102.

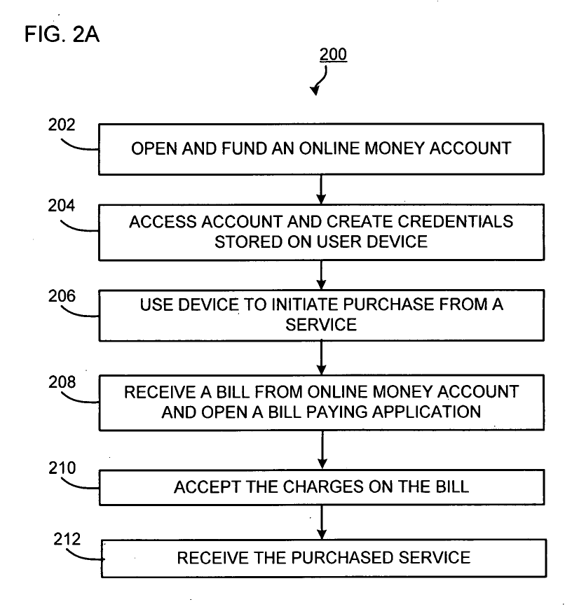

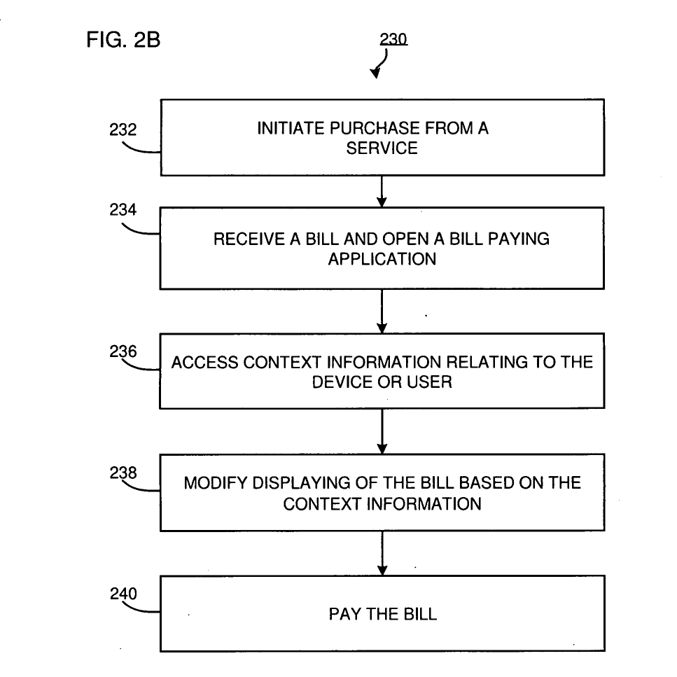

FIG. 2A is a flowchart 200 of a process for making an online payment, in accordance with one embodiment. Thus, to utilize the system described above with respect to FIG. 1, a user will open and fund, in step 202, an online-accessible account that will be used to conduct fee-based transactions with online service providers. As a part of this process, the user will generate a set of credentials that can be used to authenticate their identity and any instructions when communicating with the entity holding the online-accessible money account.

In step 204, the step of creating the credentials can be performed using a mobile device of the user. The user accesses the online money account and performs an initial session in which their identity and other information is established and a set of credentials is generated. In this way, the credentials can be easily created and automatically stored on the user's device. Alternatively, the user may generate the credentials using other systems such as a home computer and then transfer the credentials electronically from that other system to the mobile device. As mentioned earlier, the credentials may, for example, include public and private RSA cryptography keys or similar type keys for conducting encrypted communication.

The initial funding of the account and any periodic replenishment can be performed using a wide variety of sources of money such as credit cards, debit cards, online payment services, billing through a network operator, cash, etc. Once the online money account is established and funded, the user can use their mobile device, in step 206, to initiate a purchase from a service provider of a fee-based service. Although not explicitly shown as a step in FIG. 2A, the service provider will likely contact the online money account regarding the pending purchase. As a result, in step 208, the user receives at their user device a bill from the online money account. In response to receiving the bill, a bill paying application is automatically invoked. Part of the purpose of the bill paying application is to display the bill to the user in the user interface of the device. In such a display, the user can be presented with menu selection items that allow them to either authorize or reject the bill.

In at least one embodiment, receipt of a bill is automatically detected much like Multipurpose Internet Mail Extensions (MIME) types are now used to automatically open the appropriate helper application to handle web content. As such, when the user is using a browser to make a purchase from a service provider, the initiation of the purchase can result in a new browser window (or a new page in the current window) opening to display a bill received from the online money account.

In step 210, the user chooses to authorize the bill or reject it and sends that information back to the online money account. Assuming the user authorizes paying the bill, the service provider is informed and, in step 212, the user receives the purchased service. As described in more detail later, at different times during the purchase process, encrypted and/or signed messages may be transmitted and received using the credentials stored on the user device.

A user may routinely make similar purchases or may have preferences about how some online transactions will occur. Thus, there are benefits to using the contextual information about the user and the user's device to make online purchases easier and more streamlined. For example, if a user routinely purchases a travel voucher when they enter a bus station or a train depot, then the user device can automatically open a interface for making that purchase when the user device determines it is at the appropriate location. The user device can determine its location using Global Positioning System (GPS) services or local information services that broadcast messages identifying the location explicitly.

This contextual information may be further refined by storing historical transaction information in the user device. For example, if an application is opened for purchasing a train ticket that includes user-fillable fields to define the purchase, then stored contextual information can be used to automatically fill in some fields so that the transaction can occur more easily. Contextual information can be a wide variety of information about the state of the user, the state of the user device, the state of the environment, the state of the transaction, a historical transaction information. The following list of contextual information is provided by way of example to show the breadth of different data that can be included; it is not meant as an exhaustive list of what contextual information is limited to. For example, contextual information can include the local time where the user device is, the UTC (Coordinated Universal Time) time where the user device is, the semantic name of the user device's location, the user device's absolute location (e.g., GPS coordinates), whether the user device is busy, available, disconnected, the proximity of others in user communities which the user device is a participant, the battery state of the device, the history of usage with a particular service provider, physical information about the environment, and deduced information such as whether the present communications environment is secure or insecure, or whether some restriction on service is being enforced.

By having this contextual information available at the user device it can be used to customize the operation of the bill paying application as well as other applications on the user device. For example, if it is the middle of the night and the user device is not located at a predetermined location (e.g., home), then all bill paying can be disabled. Or, all bill paying exceeding a preset limit can be disabled. Another customization can be that if a user is at a pre-arranged event with others in their online community, then purchases may be shared amongst those nearby. Also, the user device can determine that it is at a location where previous purchases have been made and automatically open an application to make a similar purchase at the present time. The state of the battery can be used to warn a user that there may not be sufficient power left for a pending transaction to be completed or to send a warning message to nearby community members that the user device is going offline.

FIG. 2B is a flowchart 230 of a process for utilizing context information when making an online payment, in accordance with one embodiment. As before, the user device is used to initiate a purchase, in step 232, that results in receiving a bill, in step 234. As part of the purchase process, in step 236, contextual information stored, or available, at the user device is accessed in order to customize the process for the user according to their preferences. Accordingly, the user device includes an interface that allows the user to define what contextual information should be used and what are their preferences for using the contextual data. By setting their preferences as desired, a user can customize how online transactions are presented and paid using the user device, in step 238.

In the course of a transaction, a bill is received from an online money account provider and presented to a user through the interface of the user device. As discussed above, the way this bill is handled and presented can be customized in a wide variety of ways based on contextual information and the user's settings of how to use this information. Once presented with the bill, the user can elect, in step 240, to authorize paying the bill.

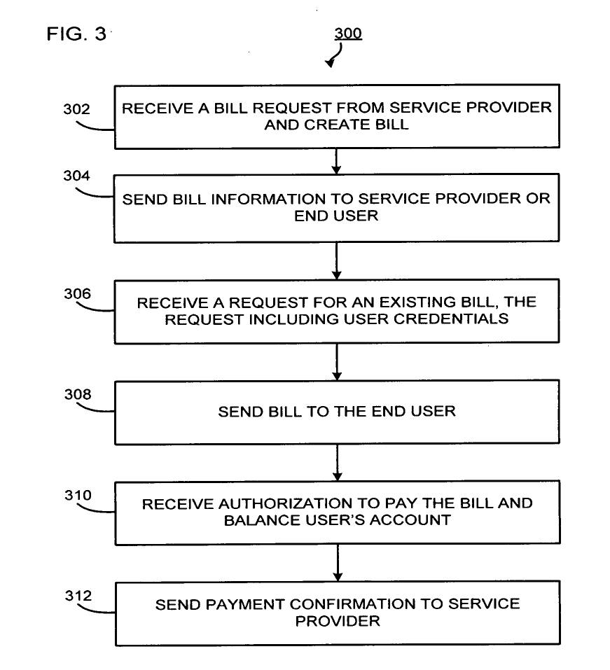

FIG. 3 is a flowchart 300 of a process for handling an online payment, in accordance with one embodiment. An online money account system may have numerous accounts corresponding, respectively, to a number of different users. Eventually, one of these users will initiate a purchase with a service provider for a fee-based service. As a result, in step 302, a bill request will be received from an online service provider and a bill will be created. In at least one embodiment, the bill request will include a user credential that identifies the end user requesting the service from the service provider.

In step 304, bill information will be sent to the end user directly or to the service provider to forward to the end user. The bill information identifies the bill created in step 302 and provides the recipient enough information to request the bill. Thus, in step 306, a request for an existing bill is received. This request includes user credentials that authenticate that the user device used to send the request is permitted to receive the bill. Assuming proper authentication occurs, the bill is sent in step 308. In response, an authorization to pay the bill is received, in step 310 (alternatively as message to reject the bill may be received). Once authorization to pay is received, then the user's account is adjusted to show the new balance. Also, the corresponding funds are transferred to an account designated by the service provider as well. In step 312, a confirmation is sent to the service provider to confirm that payment was received.

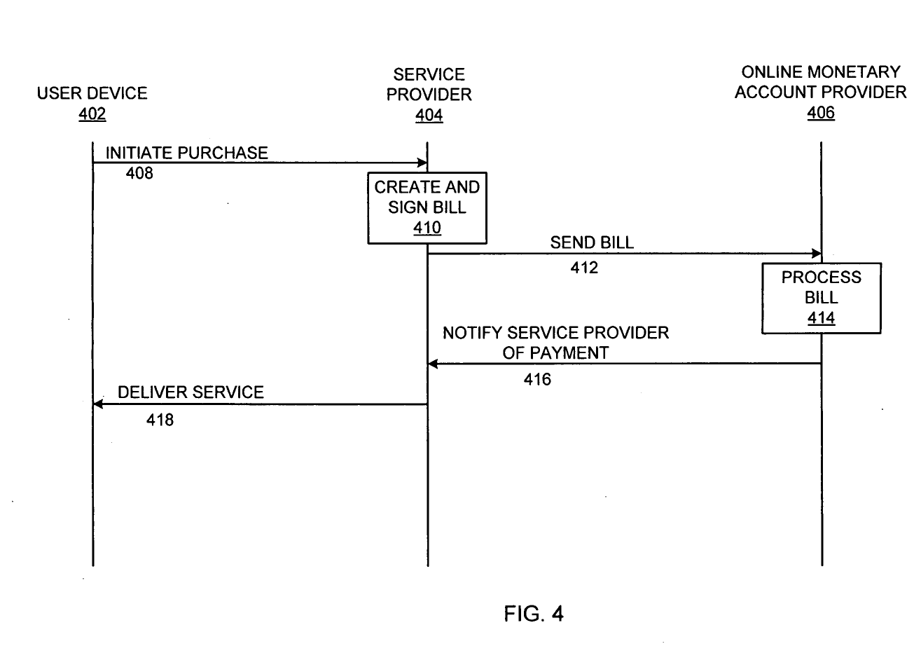

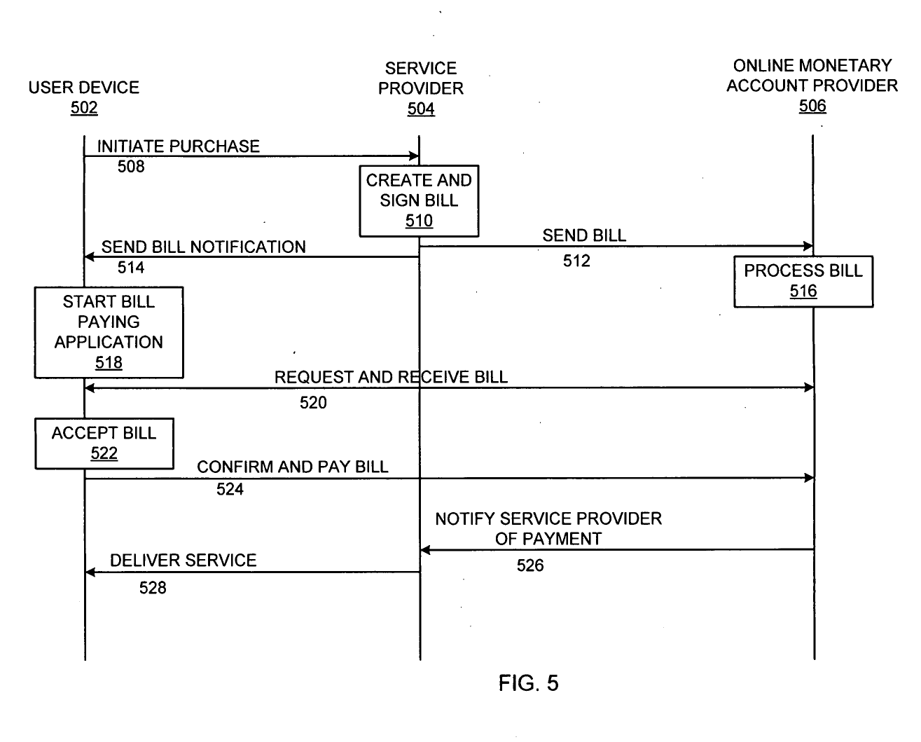

FIG. 4 is a diagram of a protocol for making online payments, in accordance with one embodiment. In some instances, the contextual information may include information about whether a direct debit contract is in place for certain service providers. If such a contract is in place, then when a bill request from that service provider is received the online money account provider automatically pays the bill without first sending it to the end user for authorization. The diagram of FIG. 4 describes such an arrangement; later FIG. 5 describes a transaction in which there is not a direct debit contract in place.

An online purchase of a service involves a user device 402, a service provider 404, and an online monetary account provider 406. In the course of operation, a purchase is initiated (408) between the user device 402 and the service provider 404. In response, the service provider creates and signs a bill (410) that is forwarded (412) to the online monetary account provider 406. In at least one embodiment, a portion of the bill is signed using credentials provided by the user device 402 to the service provider 404. Other portions may be signed using credentials of the service provider 404 as well. This bill, or bill request, describes the purchase transaction being performed at the service provider 404.

In response to receiving the bill, the online monetary account provider processes the bill (414) to create its own bill that can be retrieved by the user device 402. As mentioned earlier, if a direct debit contract is in place, then the online monetary account provider 406 automatically pays the bill without further communication with the end user. However, the end user may still want to view transactions so the bill can be stored by the online monetary account provider 406 for a period of time. The provider 406 then communicates (416) to the service provider 404 confirmation that the bill has been paid thereby allowing the service provider 404 to deliver the service (418) to the user device 402.

FIG. 5 is a diagram of another protocol for making online payments, in accordance with one embodiment. The transaction flow in FIG. 5 is similar to that of FIG. 4 in that includes a user device 502, a service provider 504, and an online monetary account provider 506. Similarly, also, the user device 502 initiates a purchase (508) with the service provider 504 that creates and signs a bill (510). Again, this bill can be signed, or encrypted, using the credentials stored on the user device 502. The bill can then be sent (512) to the online monetary account provider 506 and a bill notification may be sent (514) to the user device 502. These communications about the bill can be accomplished in a variety of different ways. One example would be for the online monetary account provider 506 to send bill information to the service provider 504. The service provider 506 can then create a bill message that is forwarded to the user device 502. For example, assuming the service provider 504 is a web site and the user device 502 uses a browser to access the site, then the service provider 504 can generate a bill notification message that automatically triggers the browser to perform certain actions. Alternatively, the bill notification message may come directly from the online monetary account provider 506, as well. The bill is processed (516) by the online monetary account provider 506 in order to present to an end user through the user device 502.

In response to the bill notification message, the user device 502 can invoke a bill paying application (518) that communicates with the online monetary account provider 506. Using the user credentials on the user device 502 along with information about the bill included in the bill notification message, the user device 502 requests the appropriate bill and receives it (520) from the online monetary account provider 506. After receipt, the bill can be displayed on the user device 502. The user device can then accept the bill (522) and send the confirmation (524) to pay the bill to the online monetary account provider 506. The messages generated by the user device 502 may be signed or encrypted using the credentials stored therein.

After receiving authorization, the online monetary account provider 506 notifies (526) the service provider 504 of payment thereby allowing the service provider 504 to deliver the paid-for service to the user device 502.

The systems, methods, and protocols described above can also be used to easily share the cost of a purchase among a plurality of different users. For example, when the initial purchase is made by an individual user, part of the purchase information can include the identity of other users who will share in paying for the purchase. In some instances, the purchase price can be shared equally or the amount each user is expected to contribute can be explicitly provided. When creating the bill, the service provider forwards that information to the online monetary account provider so that individual bills can be generated for each user. The phrase “individual bills” intended to encompass a single bill that has separate amounts allocated to a particular end user as well as multiple, separate bills. When the initial purchaser receives notification of the bill, that information can be forwarded to the other users. Using that information, the users access their bill and pay their portion to complete the transaction. This transaction can take place such that the purchase is not final until all users pay their portion or it can take place that the initial purchaser pays the full price and is reimbursed by the other users after-the-fact when they pay their bills.

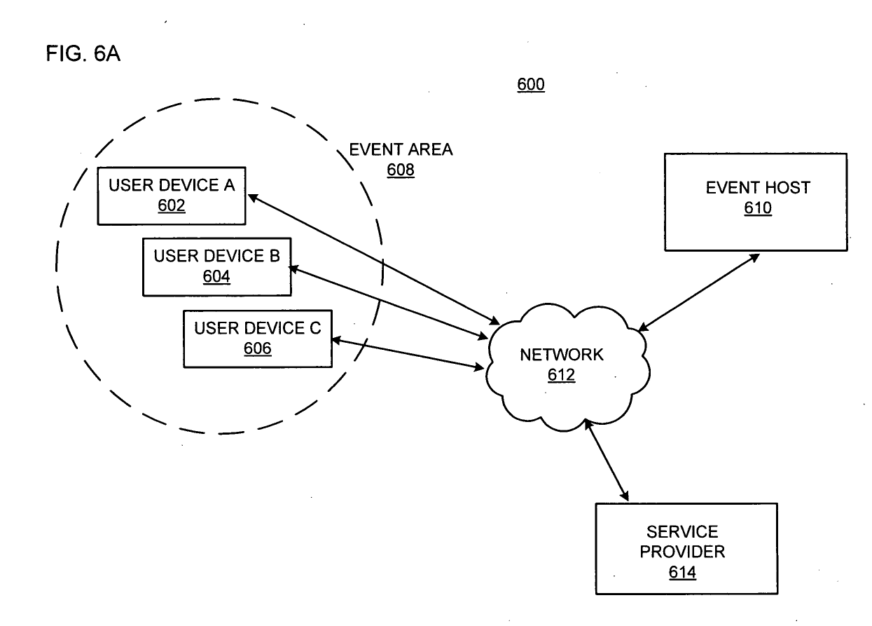

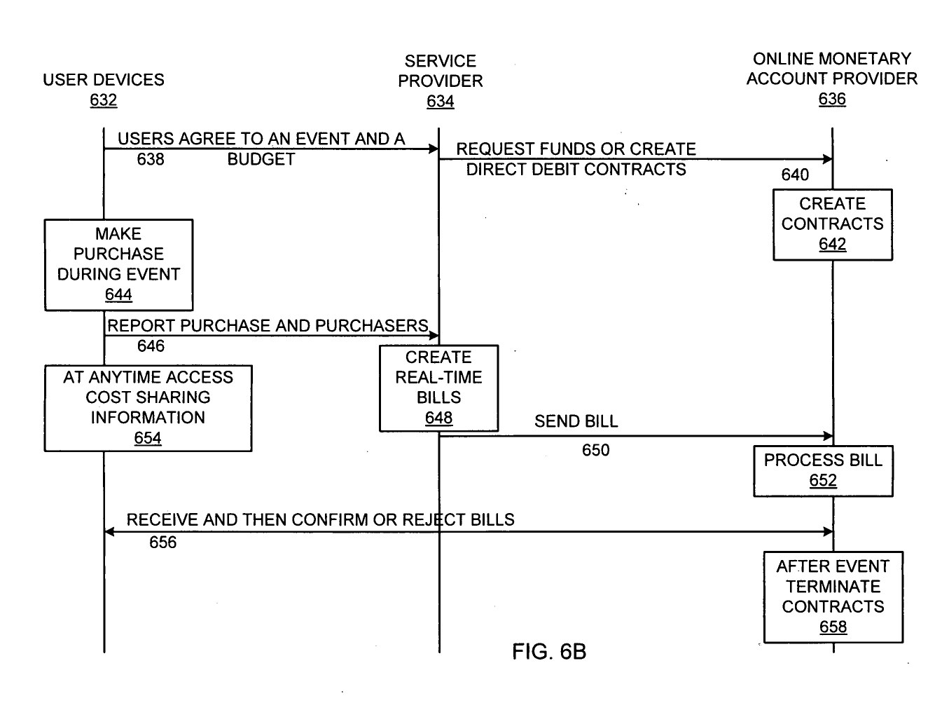

FIG. 6A is a diagram of a communications system 600, in accordance with one embodiment. The system 600 includes an environment in which a number of different users have agreed to participate in an event and agreed to splitting the costs in some fashion. Such arrangements can typically made through an event host. User devices 602, 604, 606 of different users are within an prearranged event area 608 that the users agreed to attend using the event host 610. In operation, one of the users would typically connect through a network 612 to the event host 610 to access a service provided by the event host 610 to define an event such as a bowling party, a night at a restaurant, or a concert. Once defined, the other users can visit the event host 610 and register to attend the event. Part of the event registration can be to set a budget for the event and establish an agreement between the participants regarding how and what costs will be shared. During the event, the users will use their devices 602, 604, 606 to make purchases through a service provider 614 or may make the purchases manually as well. The allocation and payment of these services is controlled by the event host 610. In some instances, the event host 610 and the service provider 614 may be the same entity. For example, if the event host 610 is a concert arena, then the service provider 614 may be a food or drink establishment within the arena. The protocol diagram of FIG. 6B relates to one embodiment for implementing billing for event purchases as just described.

The protocol of FIG. 6B helps explain one example embodiment of implementing the communication between users of multiple user devices 632, a service provider 634, and an online monetary account provider 636. The users of the user devices 632 inform (638) a service provider 634 of an event and a budget for that event that the users wish to participate in. In response, the service provider will either request (640) funds or establish direct debit contracts with the online monetary account provider. For example, the budget amount may be transferred to an account of the service provider 634 or direct debit contracts my be created (642) for the amount.

When the user devices 632 are within the event area, the contextual information stored in the devices may be used to determine that the participants of the event are assembled together. In one embodiment, the activation of the direct debit contracts or the transfer of funds may be delayed until the presence of the participants is detected at the event. While at the event one of the users will make a purchase (644). For example userA may purchase three beers, one for herself and one each for userB and userC. When making the purchase, userA will indicate the way the bill is to be allocated between the various participants. The purchase of the three beers may be evenly allocated amongst the three users; however, other purchases may not be. For example if userA purchases some clothing only for themselves, then that purchase may not be allocated amongst the other participants.

The purchase may be made using the user device to automatically communicate with a system at the service provider 634 or the purchase can be made manually and its details separately sent by the purchaser to the service provider 634. In either instance one of the user devices 632 reports (646) a purchase and the purchasers to the service provider 634. The service provider 634 can then create a real-time bill (648) that is sent (650) to the online monetary account provider 636 where it can be processed (652). At any time during the event, any of the user devices 632 can access (654) the purchases and cost sharing information for the event by accessing that information from either the online monetary account provider 636 or the service provider 634. Alternatively, the user device 632 itself may store the information about event purchases as well.

When sending (650) the bills, the service provider 634 may send a single bill that the online monetary account provider 636 separates into the appropriate number of bills during processing or the service provider 634 can itself send multiple bills reflecting the different participants in the underlying purchase transaction. If direct debit contracts are in place, then the bills can be paid from the appropriate user accounts. A confirmation may be sent to the user devices 632 as a courtesy. When no direct debit contracts are in place, then a notification of the bill (656) can be sent to each of the user devices 632 where each user can accept or reject the bill. After the event contracts can be terminated (658) and accounts balanced to reflect the purchases made.

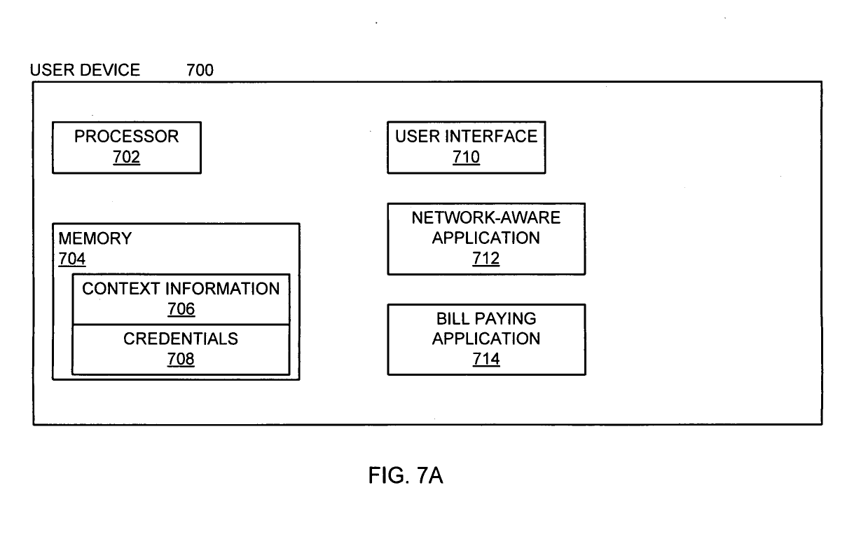

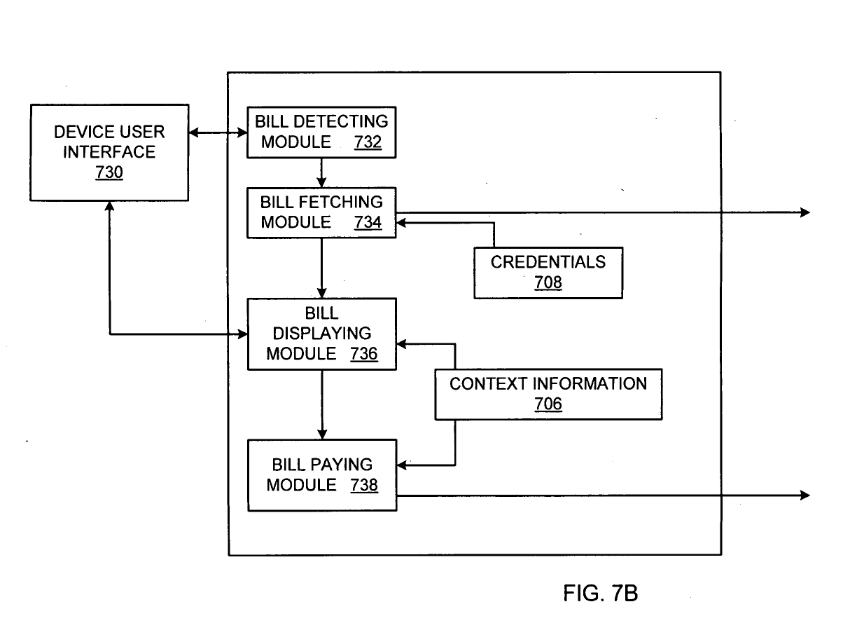

FIG. 7A is a system diagram of functional components of a mobile user device 700, in accordance with one embodiment. The device 700 includes a process 702 and memory 704 that provides a variety of communication services and applications. To facilitate at least some of these services and applications, context information 706 and user credential 708 are stored within the memory 704. As discussed above, the context information 706 can encompass a wide variety of information about the user device and its environment. The credentials 708 include information that allows the user device 700 to authenticate the identity of a user with some other system regarding the data or messages sent and received by the user device. It is noted that credentials 708 within memory 704 constitute a secure element. In one embodiment, a secure element includes both memory for storing secure information and internal processing logic to perform cryptographic functions, e.g., public-key cryptography, such as RSA. The secure element thus can reside on a user device platform or on an external memory card (e.g., a SIM card), providing access to secure information through proper authorization.

The device 700 also includes a user interface that, among other things, allows a user to interact with executable applications. One such application can be a network aware application 712 which permits the user device 700 to communicate with other devices and systems through a network. A web browser is one example of such an application 712 that allows a user device 700 to access various services offered by different service providers. When using the application 712, a user of the device 700 may encounter a service for which a fee is charged and then desire to initiate payment of that fee. Accordingly, a bill paying application 714 is also included. The network-aware application 712 and the bill paying application 714 operate in conjunction with one another to complete a transaction for a service requiring a fee. These applications initiate a communication the authorizes an online monetary account provider to pay the fee for the service requested from the service provider.

FIG. 7B is a system diagram of functional components that are a portion of a bill paying application, in accordance with one embodiment. The bill paying application, whether implemented in software, hardware or both, communicates with the user interface 730 of a user device. For example, when a bill or bill notification is received at the device user interface 730 a bill detecting module 732 detects that event and invokes a bill fetching module 734 to initiate receipt of that bill from an online monetary account provider. In retrieving the bill, the bill fetching module 734 may utilize the credentials 708 to formulate the request for the bill. When the bill is received, a bill displaying module 736 is executed to initiate displaying the bill using the device user interface 730. The user can then indicate using that interface 730 whether or not to accept the bill. Based on the user's decision, the bill displaying module 736 can communicate that information to a bill paying module 738 which formulates a message for the online monetary account provider. This message may be encrypted or signed using the credentials 708 in order to provide more secure communicates. As discussed above, context information 706 may be used by both the bill displaying module 736 and the bill paying module 738 to allow users to customize with personal preferences how some bills are displayed or paid.

The processes described herein for making and handling online transactions and payments may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

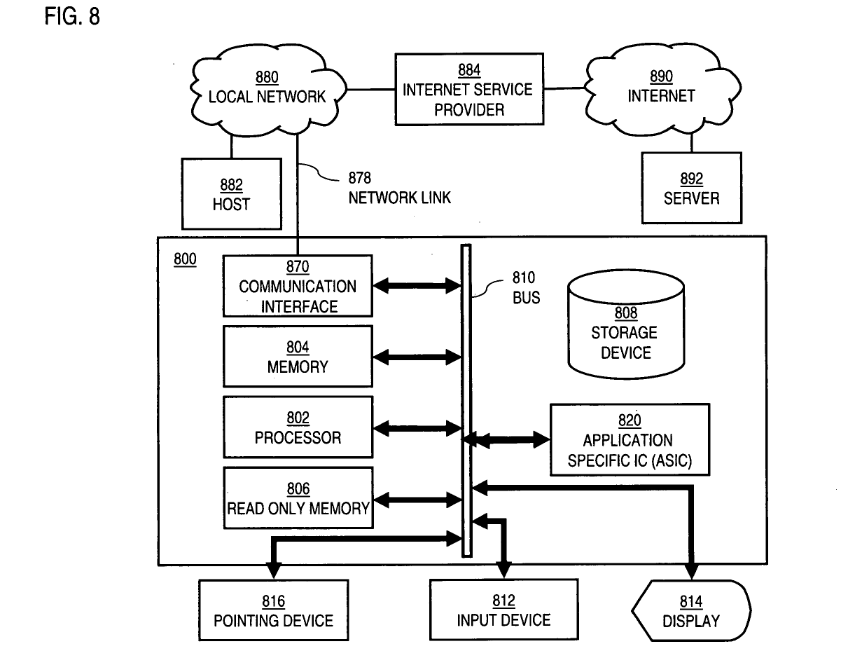

FIG. 8 illustrates a computer system 800 upon which an embodiment of the invention may be implemented. Computer system 800 is programmed to carry out the inventive functions described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

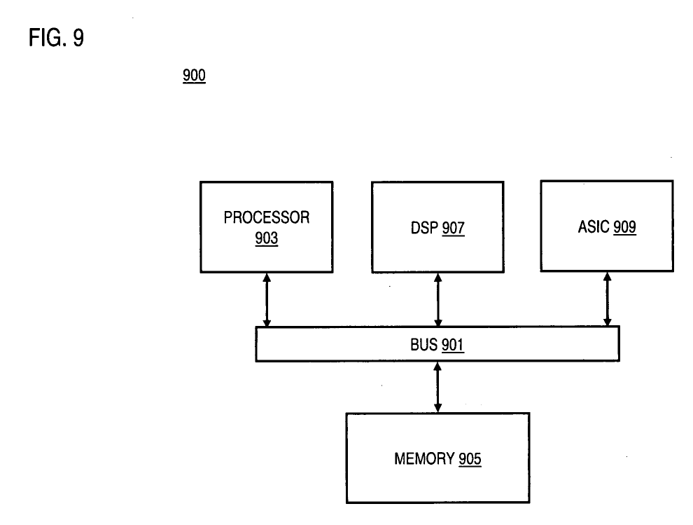

FIG. 9 illustrates a chip set 900 upon which an embodiment of the invention may be implemented. Chip set 900 is programmed to carry out the inventive functions described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-word signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein. The memory 905 also stores the data associated with or generated by the execution of the inventive steps.

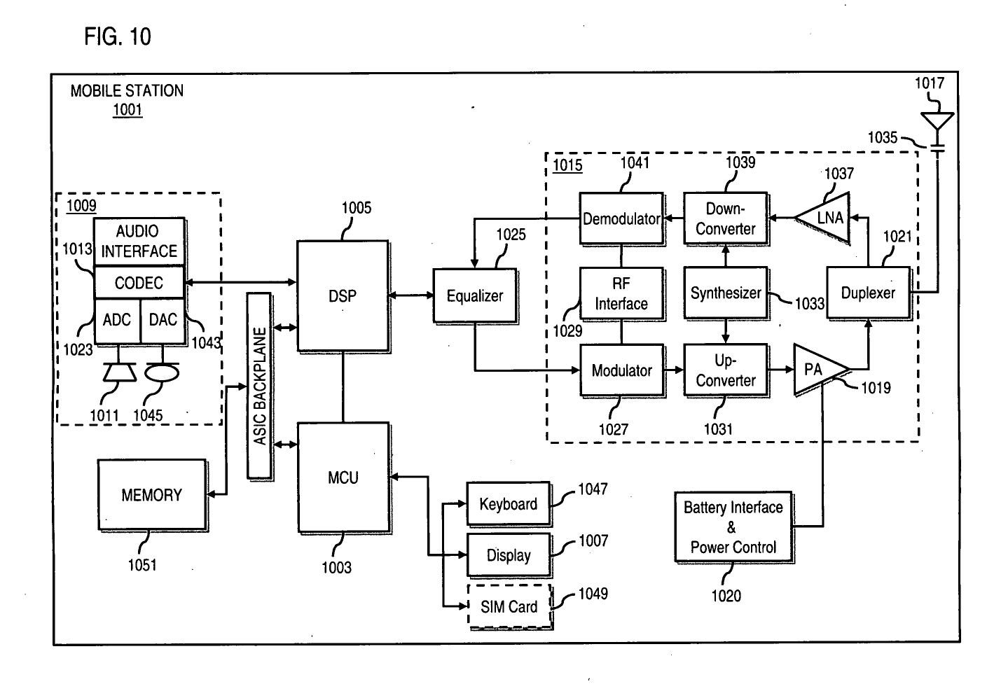

FIG. 10 is a diagram of exemplary components of a mobile station (e.g., handset) capable of operating in the system of FIG. 1, according to an exemplary embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving an indication that information identifying a bill is available;
retrieving a user credential associated with the bill;
generating a request for the bill, including the user credential and the information; and
generating a bill authorization message.

2. A method of claim 1, wherein the user credential includes encrypted information.

3. A method of claim 1, further comprising:
receiving the bill; and
initiating displaying of the bill.

4. A method of claim 1, wherein the user credential is retrieved from a memory of an a handset configured to communicate over a communication network that includes a wireless network.

5. A method of claim 1, further comprising:
determining contextual information related to the bill.

6. A method of claim 1, further comprising:
initiating a purchase of a service corresponding to the bill; and
receiving the service.

7. A method of claim 6, wherein the bill relates to a purchase whose payment is shared by a plurality of users.

8. A method of claim 7, further comprising:
determining a respective identity of the plurality of users;
determining a portion of the bill to be paid by each of the plurality of users; and
wherein the bill is for an amount equal to the portion.

9. A computer-readable storage medium carrying one or more sequences of one or more instructions which, when executed by one or more processors, cause the one or more processors to at least perform the following steps:
receiving an indication that information identifying a bill is available;
retrieving a user credential associated with the bill;
generating a request for the bill, including the user credential and the information; and
generating a bill authorization message.

10. A computer-readable storage medium of claim 9, wherein the user credential includes encrypted information.

11. A computer-readable storage medium of claim 9, further including instructions, which when executed by one or more processors, cause the one or more processors to at least perform the following steps:
receiving the bill; and
initiating displaying of the bill.

12. A computer-readable storage medium of claim 9, wherein the user credential is retrieved from a memory of an a handset configured to communicate over a communication network that includes a wireless network.

13. A computer-readable storage medium of claim 9, further including instructions, which when executed by one or more processors, cause the one or more processors to at least perform the following steps:
determining contextual information related to the bill.

14. A computer-readable storage medium of claim 9, further including instructions, which when executed by one or more processors, cause the one or more processors to at least perform the following steps:
initiating a purchase of a service corresponding to the bill; and
receiving the service.

15. A computer-readable storage medium of claim 9, wherein the bill relates to a purchase whose payment is shared by a plurality of users.

16. An apparatus comprising a processor and a memory storing executable instructions that if executed cause the apparatus to at least perform the following:
receiving an indication that information identifying a bill is available;
retrieving a user credential associated with the bill;
generating a request for the bill, including the user credential and the information; and
generating a bill authorization message.

17. An apparatus of claim 16, wherein the apparatus is included in a handset configured to communicate over a communication network that includes a wireless network.

18. An apparatus of claim 16, wherein the user credential includes encrypted information.

19. An apparatus of claim 16, further comprising a memory and wherein the user credential is retrieved from the memory.

20. An apparatus of claim 16, wherein the bill relates to a purchase whose payment is shared by a plurality of users.
